(19) United States
(12) Patent Application Publication
(10) Pub. No.: US 2025/0353673 A1
(43) Pub. Date: Nov. 20, 2025

(54) SECONDARY BATTERY SEMI-FINISHED PRODUCT MIXED LOADING DEVICE

(71) Applicant: SK On Co., Ltd., Seoul (KR)

(72) Inventors: Min Jae JEON, Daejeon (KR); Dong Hwan KIM, Daejeon (KR)

(21) Appl. No.: 19/206,069

(22) Filed: May 13, 2025

(30) Foreign Application Priority Data
May 14, 2024 (KR) 10-2024-0062850

(51) Int. Cl. B65G 1/04; B65H 49/38

(52) U.S. Cl. CPC B65G 1/0407; B65H 49/38; B65H 2701/19

(57) ABSTRACT

A secondary battery semi-finished product mixed loading device for loading a secondary reel or roll according to the present disclosure includes: a rack erected vertically on ground; a tray loaded on the rack; and a stacker crane transporting the tray and loading the tray on the rack, in which the secondary battery reel or roll may be mounted on the tray.

### CROSS-REFERENCE TO RELATED APPLICATIONS

This application claims priority under 35 U.S.C. § 119 to Korean Patent Application No. 10-2024-0062850, filed on May 14, 2024 in the Korean Intellectual Property Office, the disclosure of which is incorporated herein by reference in its entirety.

### TECHNICAL FIELD

The following disclosure relates to a loading device for storing a secondary battery reel or roll.

### BACKGROUND

A secondary battery is cut into a roll-shaped sheet to a required width by a slitter after a sheet press process. The cut sheet is divided into a long-width semi-finished product or a short-width semi-finished product according to a cutting width.

Here, the short-width semi-finished product is wound around a reel, and the long-width semi-finished product is wound around a roll. The semi-finished product wound around such a reel or roll is loaded onto a tray. The tray is stored in or transported to a reel warehouse for subsequent processes.

Since the tray loads the reel or roll, the number of trays corresponds at least one to one to the number of reels or reels. In addition, the tray should be greater than or equal to the amount required to correspond to the daily volume and storage days of the reels or reels for secondary battery production.

In addition, racks for loading the reels or rolls are required separately, and thus, a separate loading space is also required.

### SUMMARY

An embodiment of the present disclosure is directed to a secondary battery semi-finished product mixed loading device capable of mixedly loading a reel and a roll as a secondary battery semi-finished product.

In one general aspect, a secondary battery semi-finished product mixed loading device for loading a secondary reel or roll includes: a rack erected vertically on ground; a tray loaded on the rack; and a stacker crane transporting the tray and loading the tray on the rack, in which the secondary battery reel or roll is mounted on the tray.

The tray may include a reel tray loading the secondary battery reel or a roll tray loading the secondary battery roll, and the reel tray or the roll tray may be selectively loaded on the rack.

The reel tray may include: a plate; and a reel frame installed on an upper portion of the plate.

The roll tray may include: a plate; and a roll frame installed the upper portion of the plate.

In the reel tray, the plate may be used in common with the roll tray.

In the roll tray, the plate may be used in common with the reel tray.

The reel frame may be installed vertically on the plate, and the reel frame may have a cantilever where a center of the secondary battery reel is inserted and supported.

The number of cantilevers may be plural.

The roll frame may have a pair of supports that support a center of the secondary battery roll from both sides and are installed vertically on the plate.

In another general aspect, a secondary battery semi-finished product storage warehouse having a plurality of the secondary battery semi-finished product mixed loading devices may be provided.

### BRIEF DESCRIPTION OF THE DRAWINGS

FIG. 1 is a diagram illustrating loading a tray mounted with a secondary battery reel in a secondary battery semi-finished product mixed loading device according to an embodiment.

FIG. 2 is a diagram illustrating loading a tray mounted with a secondary battery roll in the secondary battery semi-finished product mixed loading device according to an embodiment.

FIG. 3 is a conceptual diagram of a rack and a stacker crane in the secondary battery semi-finished product mixed loading device according to an embodiment.

FIG. 4 is a diagram illustrating the secondary battery reel mounted on a reel tray in FIG. 1.

FIG. 5 is a diagram illustrating the secondary battery roll mounted on the reel tray in FIG. 2.

### DETAILED DESCRIPTION OF MAIN ELEMENTS

10: Secondary battery reel
20: Secondary battery roll
100: Rack
200: Tray
210: Reel tray
230: Plate
211: Reel frame
212: Cantilever
220: Roll tray
230: Plate
221: Roll frame
222: Support
300: Stacker crane

### DETAILED DESCRIPTION OF EMBODIMENTS

Hereinafter, the present disclosure will be described in detail with reference to the accompanying drawings. However, this is only an example and the present disclosure is not limited to the specific embodiments described by way of example.

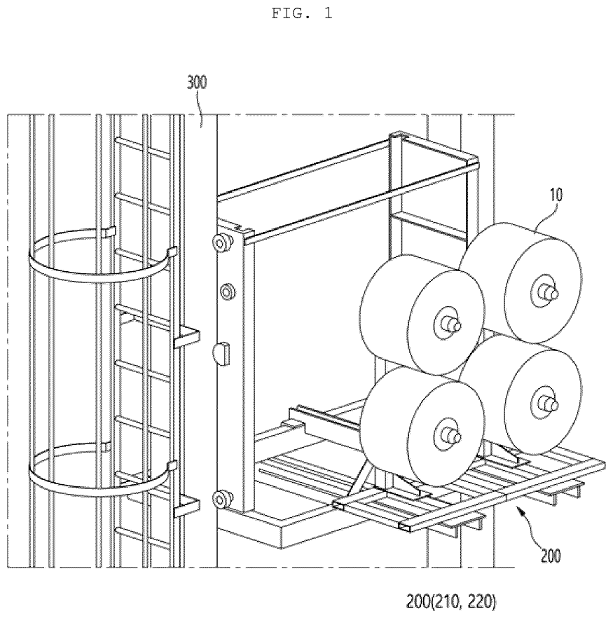

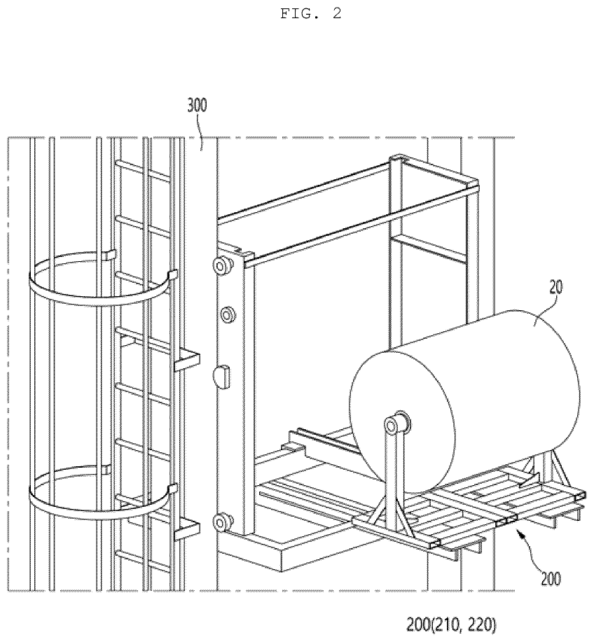

Referring to FIGS. 1 to 3, the secondary battery semi-finished product mixed loading device of the present disclosure is configured to include a rack 100, a tray 200, and a stacker crane 300.

A secondary battery reel 10 and a secondary battery roll 20 are in the form of a secondary battery semi-finished product, and may be configured in the form of a circular reel or roll used in a secondary battery manufacturing process depending on a length of a width of the semi-finished product. The secondary battery reel 10 or roll 20 may perform a function of winding and storing or transporting electrodes or other components of the secondary battery.

The rack 100 may be a frame-shaped structure erected vertically on the ground. The rack 100 may be configured to have a loading space divided so that a plurality of trays 200 may be mounted.

The rack 100 may perform a function of stably supporting the tray 200 and storing the secondary battery reel 10 or roll 20 mounted on the tray 200. The rack 100 may be manufactured in various sizes and shapes, and the arrangement of the loading space in the vertically erected frame-shaped structure may be configured in vertical and horizontal directions.

The tray 200 may have the secondary battery reel 10 or roll 20 thereon to be loaded onto the rack 100.

The stacker crane 300 may transport the tray 200 which has the secondary battery reel 10 or roll 20 mounted thereon and is mounted on the rack 100, and load the tray 200 onto the rack 100.

The stacker crane 300 may be a device that may transport the secondary battery reel 10 or tray 200 to be loaded the rack. For example, the stacker crane 300 may be a mechanical crane, an electric crane, a hydraulic crane, a pneumatic crane, a robot crane, an automated crane, or a manual crane. However, the present disclosure is not limited thereto.

The stacker crane 300 may be configured to stably transport the secondary battery reel 10 or the tray 200. The stacker crane 300 may include a structure that may move in the vertical and horizontal directions to load the secondary battery reel 10 or the tray 200 onto the rack. The stacker crane 300 may include a position control device to dispose the secondary battery reel 10 or the tray 200 at an accurate position. The stacker crane 300 may be designed to have a structure with strength and stability that may support the weight of the secondary battery reel 10 or the tray 200.

This stacker crane 300 is a crane used to transport or load a load such as the tray 200, and is a publicly disclosed technology. Therefore, a detailed description and illustration thereof are omitted.

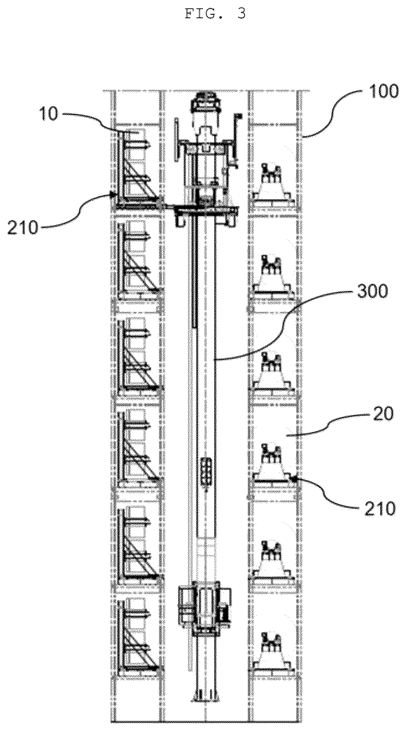

However, the stacker crane 300 may also be configured in the form that is integrally installed on the rack 100, and the type of stacker crane 300 is conceptually illustrated in FIG. 3. When integrally installed on the rack 100, the stacker crane 300 is installed vertically on the rack 100 and may transport and load the tray 200 in the loading space configured in each row and column of the rack 100.

The secondary battery semi-finished product mixed loading device according to the present disclosure is for loading the secondary batteries of the semi-finished products separately produced in the form of the reel or roll onto the same rack 100 without distinguishing the rack 100 that is the storage location.

The secondary battery reel 10 is wound with a short-width semi-finished product, and the secondary battery roll 20 is wound with a long-width semi-finished product. The lengths of the widths of the secondary battery reel 10 and roll 20 cannot but be different. The racks for loading the reel 10 and roll 20 also have different shapes, so separate racks are needed to load the secondary battery reels 10 and rolls 20.

In the secondary battery semi-finished product mixed loading device according to the present disclosure, the rack 100 may be used in common to load the secondary battery reel 10 and roll 20.

The tray 200 includes a reel tray 210 for loading the secondary battery reel 10 or a roll tray 220 for loading the secondary battery roll 20, but the reel tray 210 or the roll tray 220 may be selectively loaded onto the rack 100.

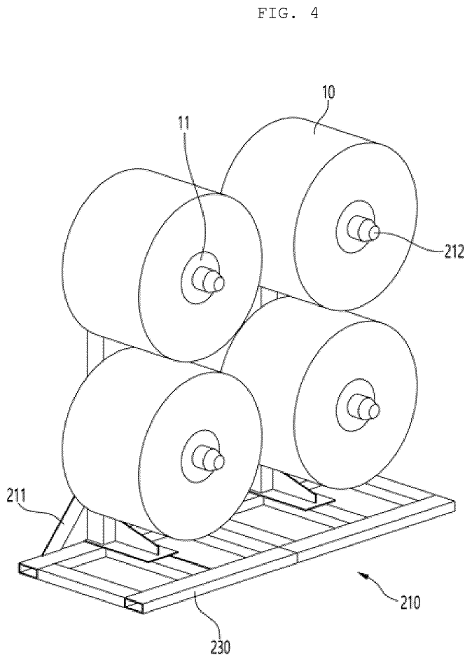

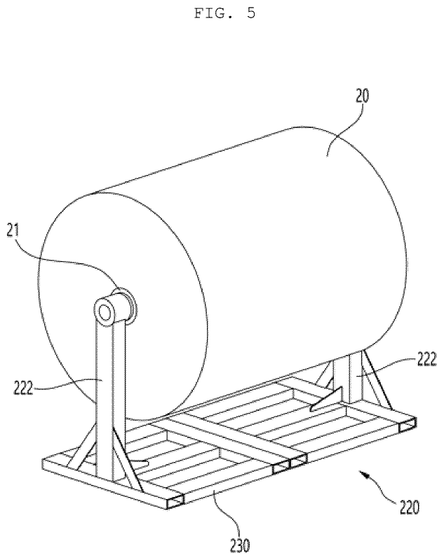

To this end, referring to FIGS. 4 and 5 together, the reel tray 210 and the roll tray 220 may use a plate 230 in common.

The plate 230 is a component that forms a bottom surface in the tray 200, and the stacker crane 300 may unload/load the secondary battery reel 10 or roll 20 onto the rack 100 by unloading/loading the plate 230.

The plate 230 may be configured in a frame shape with a flat structure that is horizontal to the ground. The plate 230 may selectively have a reel frame 211 and a roll frame 222, which will be described, installed on an upper surface thereof.

By using the plate 230 in the tray 200 in common, the rack 100 may be used in common regardless of the secondary battery reel 10 or roll 20 that is the mounting target.

By having the shape and size of the plate 230 in the reel tray 210 and the roll tray 220 in common, the space occupied by the tray 200 in the rack 100 may be equally limited.

Referring to FIG. 4, the reel tray 210 may be configured to include the plate 230 and the reel frame 211 installed on an upper portion of the plate 230.

The reel frame 211 is installed vertically on the plate 230, and the reel frame 211 may be provided with a cantilever 212 where the center of the secondary battery reel 10 is inserted and supported.

The reel frame 211 may be installed on one side of the upper portion of the plate 230. The reel frame 211 may be provided with the cantilever 212.

The position where the reel frame 211 is installed may be installed on a longitudinal side of the upper portion of the plate 230. The cantilever 212 may be installed to have a length that protrudes from the reel frame 211 in a width direction of the plate 230 but does not exceed the width of the plate 230.

The cantilever 212 is installed on the reel frame 211 horizontally with an upper surface of the plate 230 and may be inserted into a reel core 11, which is the center of the secondary battery reel 10, to support the secondary battery reel 10.

The reel core 11 is positioned at the center of the secondary battery reel 10 to provide the structural stability of the secondary battery reel 10, and may act as a central axis when the secondary battery reel 10 rotates or is fixed. The reel core 11 may generally be formed in a circular or cylindrical structure.

Since the plate 230 is horizontal to the ground, the cantilever 212 may also be installed on the reel frame 211 horizontally to the ground.

Since the cantilever 212 is configured to have a length that does not exceed the width or length of the plate 230, the secondary battery reel 10 may be positioned within the upper surface of the plate 230 when mounted on the cantilever 212.

In order to load the plurality of secondary battery reels 10, the plurality of cantilevers 212 may be installed accordingly. In this case, each cantilever 212 may be installed on the reel frame 211 to form a set interval in the horizontal direction and the vertical direction, respectively.

When the reel is wound around the reel core 11 to the set length to make the secondary battery reel 10, the secondary battery reel 10 has a set diameter. Each secondary battery reel 10 needs to have a set interval while avoiding interference with each other during loading in order to avoid damage.

In order to form a set interval between the plurality of secondary battery reels 10 in the horizontal or vertical direction, the plurality of cantilevers 212 may be installed on the reel frame 211 to have a set interval that takes into account the diameter and free interval of the secondary battery reel 10.

It is preferable that the cantilever 212 is composed of four. Referring to FIG. 4, four cantilevers 212 may be installed on the reel frame 211 while formed in a vertically stacked layer by two. Therefore, four secondary battery reels 10 may be loaded onto one reel tray 210.

Referring to FIG. 5, the roll tray 220 may be configured to include the plate 230 and the roll frame 221 installed on the upper portion of the plate 230. Here, the plate 230 may be used in common with the reel tray 210 as described above.

The roll frame 221 may be vertically installed on the plate 230 with a pair of supports 222 that support the center of the secondary battery roll 20 from both sides.

The pair of supports 222 may be installed facing each other on both sides of the upper portion of the plate 230. The position where the roll frame 221 is installed may be installed on a width direction side of the upper portion of the plate 230. The pair of supports 222 may be installed to face each other on the width direction side of the plate 230.

The pair of supports 222 may support the roll core 21 of the secondary battery roll 20 on both sides, thereby mounting the secondary battery roll 20 on the roll frame 221.

The roll core 21 is positioned at the center of the secondary battery roll 20 to provide the structural stability of the secondary battery roll 20, and may act as a central axis when the secondary battery roll 20 rotates or is fixed. The roll core 21 may generally be formed in a circular or cylindrical structure.

It is preferable that one secondary battery roll 20 is mounted on the roll frame 221, and may not be removed from the plate 230 by being mounted on the pair of supports 222 facing each other.

In this way, the reel tray 210 and the roll tray 220 are divided into the reel frame 211 and the roll frame 221 according to the shape of the secondary battery reel 10 and the secondary battery roll 20, but by using the plate 230 in common, the rack 100 for loading the tray 200 may be used in common. The plate 230 provides compatibility between the reel tray 210 and the roll tray 220, thereby increasing space utilization and improving flexibility in the manufacturing and operation processes.

The reel tray 210 and the roll tray 220 may use the plate 230 in common. The reel tray 210 may be disassembled to install the roll frame 221 and the support 222 on the plate 230, thereby making the roll tray 220. On the other hand, the roll tray 220 may be disassembled to install the reel frame 211 and the cantilever 212 on the plate 230, thereby making the reel tray 210.

In addition, a secondary battery semi-finished product storage warehouse may be configured by including the plurality of the secondary battery semi-finished product mixed loading devices described above.

According to an embodiment of the present disclosure, by storing the secondary battery reel or the secondary battery roll which is the semi-finished product, in the same rack, it is possible to increase the space utilization and operational flexibility.

The above-described contents are merely examples of applying the principles of the present disclosure, and other configurations may be further included without departing from the scope of the present disclosure.

What is claimed is:

1. A secondary battery semi-finished product mixed loading device for loading a secondary reel or roll, comprising:
a rack erected vertically on ground;
a tray loaded on the rack; and
a stacker crane transporting the tray and loading the tray on the rack,
wherein the secondary battery reel or roll is mounted on the tray.

2. The secondary battery semi-finished product mixed loading device of claim 1, wherein the tray includes a reel tray loading the secondary battery reel or a roll tray loading the secondary battery roll, and the reel tray or the roll tray is selectively loaded on the rack.

3. The secondary battery semi-finished product mixed loading device of claim 2, wherein the reel tray includes:
a plate; and
a reel frame installed on an upper portion of the plate.

4. The secondary battery semi-finished product mixed loading device of claim 2, wherein the roll tray includes:
a plate; and
a roll frame installed on an upper portion of the plate.

5. The secondary battery semi-finished product mixed loading device of claim 3, wherein in the reel tray, the plate is used in common with the roll tray.

6. The secondary battery semi-finished product mixed loading device of claim 4, wherein in the roll tray, the plate is used in common with the reel tray.

7. The secondary battery semi-finished product mixed loading device of claim 3, wherein the reel frame is installed vertically on the plate, and the reel frame has a cantilever where a center of the secondary battery reel is inserted and supported.

8. The secondary battery semi-finished product mixed loading device of claim 7, wherein the number of cantilevers is plural.

9. The secondary battery semi-finished product mixed loading device of claim 4, wherein the roll frame has a pair of supports that support a center of the secondary battery roll from both sides and are installed vertically on the plate.

10. A secondary battery semi-finished product storage warehouse having a plurality of the secondary battery semi-finished product mixed loading devices of claim 1.
